(19) United States
(12) Patent Application Publication
(10) Pub. No.: US 2010/0186707 A1
(43) Pub. Date: Jul. 29, 2010

(54) High-torque rotary radial internal combustion piston engine

(76) Inventor: Leonid Yakhnis, Haifa (IL)

Correspondence Address: Leonid Yakhnis, St. Yad Lebanim, 182/17, Haifa, 32698, IL

(21) Appl. No.: 12/321,987

(22) Filed: Jan. 29, 2009

(51) Int. Cl. F02B 53/00

(52) U.S. Cl. 123/200

(57) ABSTRACT

The engine under U.S. Pat. No. 7,421,986 comprises a pair radially opposite cylinders spaced in the plain of the working cylinders of the above engine coaxially apart in the opposite sides of the rotor along the axis being perpendicular to the above said cylinders axes and to the rotor axis and extends cross a rotor axis. There are a pistons spaced in each of said cylinders for displacement along the cylinder axis. Each of the said piston is connected respectively to the rotary ring by crankshaft. The pressure in all above cylinders afford resultant torques which act on the rotor and on the rotary ring and the balance of all resultant torques on the driven shaft ensure high affectivity of the novel engine.

### BACKGROUND OF THE INVENTION

1. Field of the Invention

The present invention relates to the machinebuilding and can be applied in the form of an internal combustion engine, a gas engine, a hydraulic motor, a gas compressor and a hydraulic pump

2. Description of the Related Art

The Rotary Radial Internal Combustion Piston Engine is the object of invention U.S. Pat. No. 7,421,986 and Israel Pat. No. 169917. It has the cylinders and pistons fully the same as the ones of the conventional engine and operates under the four-stroke internal combustion engine according to the Otto cycle. Both the piston and the cylinder are impelled by gas under pressure and rotate in the same direction and with the same velocity about two stationary and eccentrical axes correspondently. To make clear the effectivity of the above engine it is necessary to analyze the resultant torques on the driven shaft of the above engine. With the reference to illustration on the FIG. 2 (see below) the balance of all resultant torques on the driven shaft of force P is the torque of said engine:. T_{P}=P b Sin θ: (see below, part “Operation of the engine”). The resultant torque on the driven shaft of the above engine illustrated by the curve T_{P} on the FIG. 3. The area under the curve T_{P} is the effective work done by the above engine in two revolutions of the driven shaft. From the above it is clear that the effectivity of the above engine is the same as the effectivity of the conventional crankshaft engine. So, the above engine has the advantages of rotary engines, but it has the same low effectivity as the ones of conventional engine.

The aim of this invention is to increase the effectivity of rotary engine which operates under the four-stroke internal combustion engine according to the Otto cycle

### BRIEF DESCRIPTION OF THE SEVERAL VIEWS OF THE DRAWING

The invention would be described now with reference to the:

FIG. 1 illustrate the construction of the engine and a manner in which it operates.

FIG. 2 displays pistons-cylinders axes cross section plane.

FIG. 3 displays curves of gas pressure versus driven shaft angle for a 4-cycle engine, with resultant torque on the driven shaft:

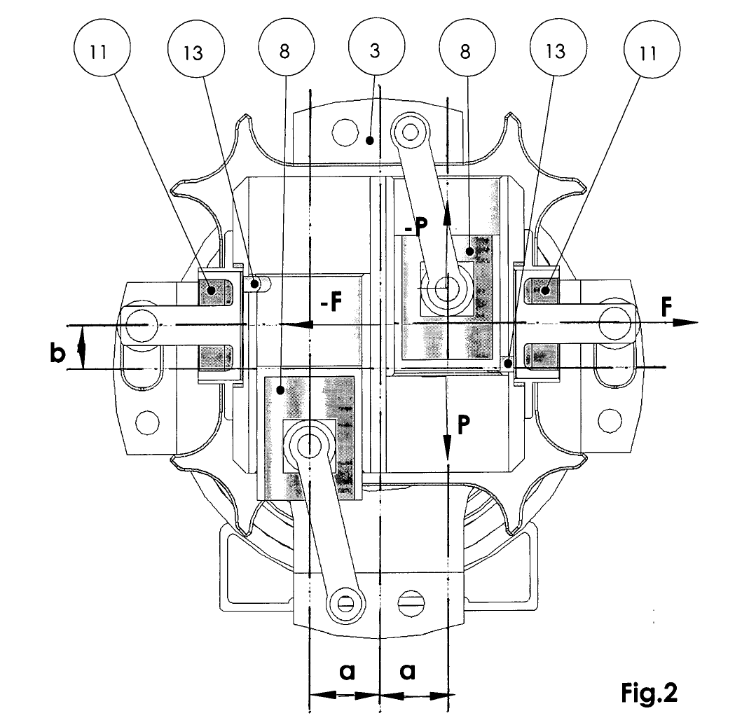

1. Measured gas pressure versus crank angle (θ) measured from firing top center of any one of the cylinders from the C. F. Taylor “The Internal-Combustion Engine in Theory and Practice”, vol. 2, second edition, FIG. 5-24, page 138,
2. Resultant torque on the driven shaft of the force P (see FIG. 2), T_{P}=P b Sin θ,
3. Resultant torque on the driven shaft of the force F (see FIG. 2), T_{F}=F b (1−Sin θ),
4. Summary resultant torque on the driven shaft—Tengine (see FIG. 2), Tengine=T_{P}+T_{F}.

### DETAILED DESCRIPTION OF THE INVENTION

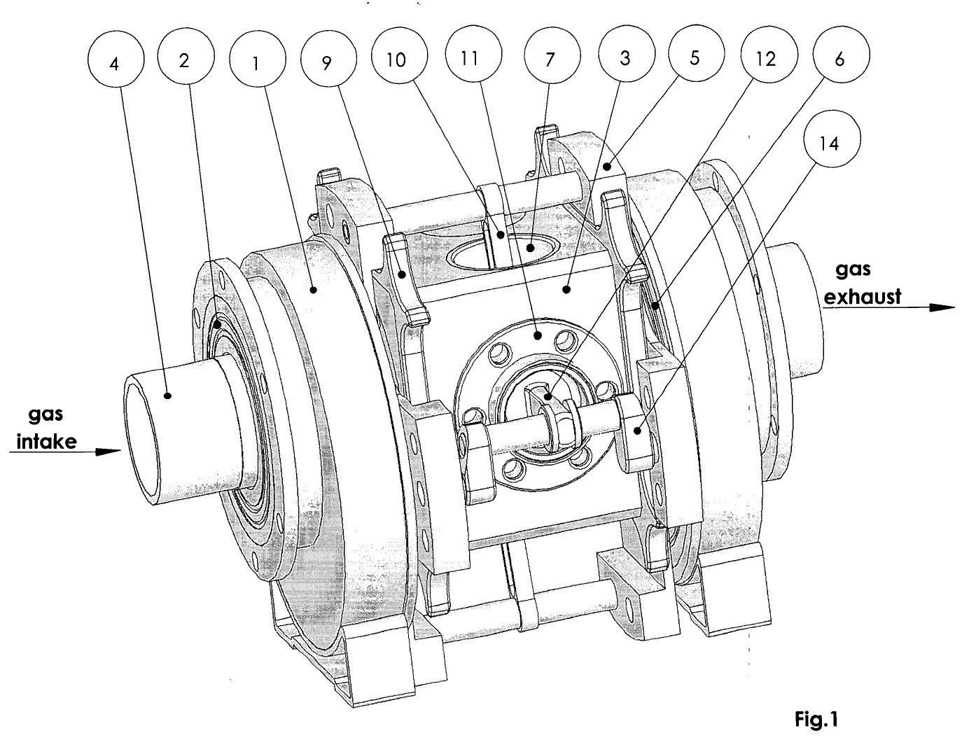

Turning first to FIGS. 1-2:

New engine comprises a housing (1), a rotor (3) having a driven shaft (4) fastened thereon, which is mounted on the bearings (2) spaced coaxially apart in the opposite sides of the housing and rotates about its axis of rotation and has a pair radially opposite working cylinders (7) spaced in the body of the rotor eccentrically and equidistantly relative to its axis of rotation. One radially outer end of each working cylinder is closed by the wall and the other end is closed by the piston (8) which slides within the working cylinder. Rotor (3) has a pair radially opposite cylinders (11) spaced in the plain of the above working cylinders (7) coaxially apart in the opposite sides of the rotor. The axis of the above cylinders (11) is perpendicular to the working cylinders (7) axes and to the rotor axis and extends cross a rotor axis. One radially outer end of each cylinder is closed by the wall and the other end is closed by the piston (12) which slides within the cylinder. Inner space of the said cylinders (11) connected to the inner space of the working cylinders (7) by mean of an inner pipes (13). Gas intake and gas exhaust may take place through the ducts in the body of the rotor. An intake duct is at an outer end of said driven shaft (4) and an exhaust duct is at an opposite outer end of said driven shaft (4). An inner pipes connect said intake duct to each of working cylinders (7) and each of said working cylinders (7) to said exhaust duct. There is a rotary ring (5) mounted on the bearings (6) spaced coaxially apart in the opposite sides of the housing. It rotates about its axis of rotation spaced apart from the rotor axis by an eccentricity and being impelled to rotate in the same direction and with the same velocity relative to the rotor by pins (9) of the rotor. The pistons (8) are connected to the rotary ring through the connecting rods (10). The pistons (12) are connected to the rotary ring through the pins (14).

In general operation of the engine, while the housing remains stationary, the rotor with the cylinders, pistons, connecting rods and the rotary ring rotate in the same direction and with the same velocity about the rotor and the rotary ring axes of rotation correspondently. The above axes are not coaxial and therefore both the piston and the cylinder slide with respect one to another. Both the cylinders and the pistons are impelled by gas under pressure. One way the force of pressure acts through the pistons and connecting rods or crankshafts to the rotary ring and through the bearings of the rotary ring to the housing. Another way it acts through the cylinders (the bottom walls of the cylinders) to the rotor and to the driven shaft. Above forces afford resultant torques which act on the rotor (3) and on the rotary ring (5) being direct mechanical connected to the above rotor and the balance of all resultant torques is the torque of the engine.

The resultant torques (see FIG. 2) which act on the said rotor and rotary ring as a function of driven shaft angle (θ) measured from firing top center of any one of the cylinders:
1. Resultant torque of the force P:
   on the rotor: T₁=P a;
   on the rotary ring: T₂=−P (a−b Sin θ)
   summary torque on the driven shaft of the engine: T_{P}=T₁+T₂=P b Sin θ
2. Resultant torque of the force F:
   on the rotor: Force F do not affords torque on the rotor because it is coaxial to the rotor axis.
   on the rotary ring: T_{F}=F b (1−Sin θ)

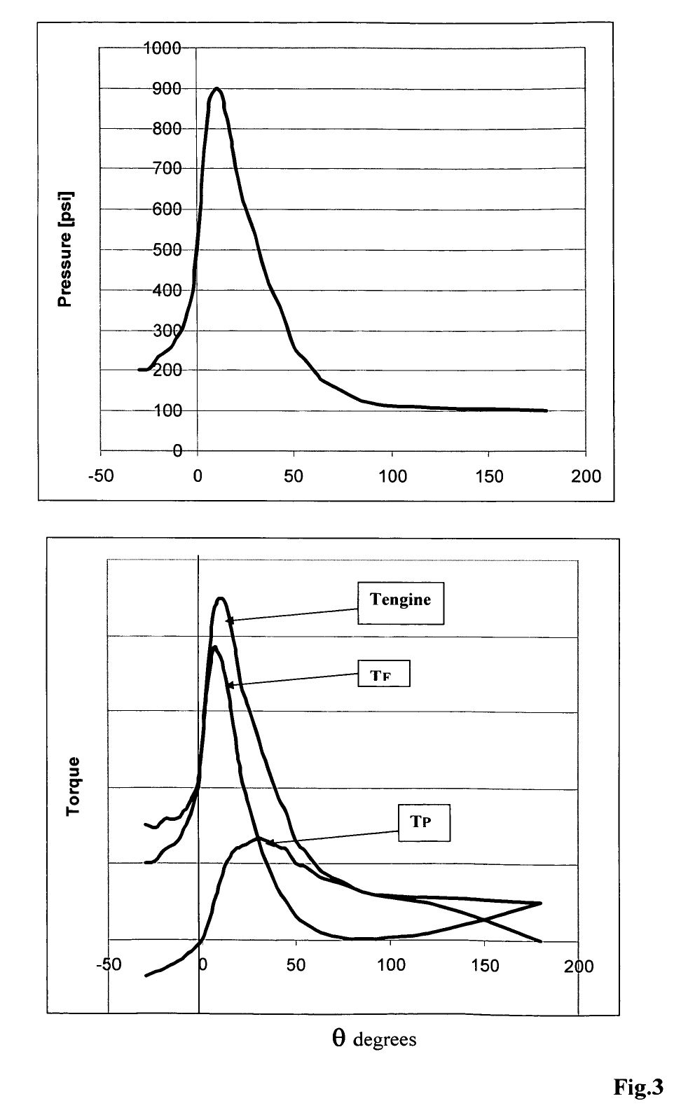

Balance of all torques on the driven shaft of the engine: Tsum=Tengine=T_{P}+T_{F}. Illustration on the FIG. 3 makes clear above balance. The area under the curve (Tengine) on the FIG. 3 is the effective work done by the novel engine in two revolutions of the driven shaft. The area under the curve (T_{P}) is the effective work done by the Rotary Radial Internal Combustion Piston Engine under U.S. Pat. No. 7,421,986 and Israel Patent No 169917 in two revolutions of the driven shaft ((there are no the cylinders (11), the pistons (12) and, therefore there are no the force F and the resultant torque of the force F on the rotor)). The balance of the said areas is the balance of the novel engine and Rotary Radial Internal Combustion Piston Engine under U.S. Pat. No. 7,421,986 and Israel Patent No 169917 effectivites.

1. A High-Torque Rotary Radial Internal Combustion Piston Engine comprises
a housing (1),
a rotor (3) having a driven shaft (4) fastened thereon,
a first set of bearings (2), wherein said driven shaft (4) mounted on, spaced coaxially apart on the opposite sides of said housing (1 ) for rotation about an axis of said rotor (3),
a rotary ring (5),
a second set of bearings (6) wherein said rotary ring (5) mounted on, spaced coaxially apart on the opposite sides of said housing (1) for rotation around an axis of said rotary ring (5) being parallel and spaced apart from axis of said rotor (3),
a pair radially opposite working cylinders (7) spaced in the body of the rotor (3) eccentrically and equidistantly relative to said rotation axis of said rotor (3),
a pair radially opposite cylinders ( 11) spaced in the plain of the said working cylinders (7) coaxially apart in the opposite sides of the rotor and the axis of the said cylinders (11) is perpendicular to the working cylinders (7) axes and to the rotor axis and extends cross a rotor axis.
an inner pipe (13) connecting inner space each of the said cylinders (11) and inner space of the said working cylinders (7) respectively,
a piston (8) spaced in each of said working cylinders (7) for displacement along the respective cylinder axes, wherein said piston (8) is connected respectively to said rotary ring (5) by connecting rods (10),
a piston (12) spaced in each of said cylinders (11) for displacement along the cylinder axis, wherein said piston (12) is connected respectively to said rotary ring (5) by pin (14),
an intake duct being at an outer end of said driven shaft (4) and an exhaust duct being at an opposite outer end of said driven shaft (4),
an inner pipe connecting said intake duct to said working cylinders (7) and said working cylinders (7) to said exhaust duct, and
pins (9);
wherein said rotary ring (5) is eccentrically relative to the rotation axis of said rotor (3), and is impelled to rotate in the same direction and at the same velocity relative to said rotor by the direct mechanical connection between said rotor and said rotary ring by said pins (9) of said rotor.
